(19) United States
(12) Patent Application Publication
(10) Pub. No.: US 2021/0189188 A1
(43) Pub. Date: Jun. 24, 2021

(54) THERMALLY CONDUCTIVE COMPOSITION, THERMALLY CONDUCTIVE SHEET AND METHOD FOR PRODUCING THE SAME

(71) Applicants: Fuji Polymer Industries Co., Ltd., Nagoya-shi (JP); TOYOTA JIDOSHA KABUSHIKI KAISHA, Toyota-shi (JP)

(72) Inventors: Yuki KAMIYA, Aichi (JP); Masakazu HATTORI, Aichi (JP); Tomoki MATSUMURA, Aichi (JP); Katsuyuki SUZUMURA, Aichi (JP); Koji NAKANISHI, Konan-shi (JP); Ayako YAMAGUCHI, Toyota-shi (JP)

(21) Appl. No.: 17/116,733

(22) Filed: Dec. 9, 2020

(30) Foreign Application Priority Data
Dec. 18, 2019 (JP) 2019-228353

(51) Int. Cl. C09J 7/35; C09K 5/14; C09J 11/04; C09J 7/10; H05K 7/20

(52) U.S. Cl. CPC C09J 7/35; C09K 5/14; C09J 11/04; C09J 7/10; C09J 2301/408; C09J 2301/304; C09J 2203/326; C09J 2483/00; H05K 7/2039

(57) ABSTRACT

A thermally conductive composition 26 contains a base polymer, an adhesive polymer, and thermally conductive particles. A thermal conductivity of the thermally conductive composition 26 is 0.3 W/mK or more. The base polymer is a silicone polymer. The adhesive polymer contains a methyl hydrogen polysiloxane, an epoxy group-containing alkyltrialkoxysilane, and a cyclic polysiloxane oligomer. The amount of the adhesive polymer is 5 to 35 parts by weight with respect to 100 parts by weight of the base polymer. A thermally conductive sheet of the present invention includes the thermally conductive composition in the form of a sheet. Thus, the present invention provides a thermally conductive composition that has high thermal conductive properties and excellent resilience and that can prevent interfacial peeling due to stress, a thermally conductive sheet including the thermally conductive composition, and a method for producing the thermally conductive sheet.

### BACKGROUND OF THE INVENTION

### 1. Field of the Invention

The present invention relates to a thermally conductive composition that has excellent resilience and is able to reduce interfacial peeling due to stress, a thermally conductive sheet including the thermally conductive composition, and a method for producing the thermally conductive sheet.

### 2. Description of Related Art

With the significant improvement in performance of semiconductors such as CPUs in recent years, the amount of heat generated by them has become extremely large. For this reason, heat dissipating materials are attached to electronic components that may generate heat, and a thermally conductive sheet is used to improve the adhesion between heat dissipating members and semiconductors. The thermally conductive sheet has been required to have a high thermal conductivity, a low steady load value, and flexibility as recent devices become smaller in size and higher in performance. Patent Document 1 proposes to improve the compressibility, insulation properties, thermal conductive properties, etc. of a thermally conductive silicone composition by setting the viscosity of the composition to 800 Pa˜s or less at 23° C. before curing. Moreover, thermally conductive compositions containing a silicone resin have recently been proposed as heat dissipating materials for heat generating components of, e.g., hybrid vehicles, electric vehicles, and fuel cell powered vehicles (Patent Documents 2 and 3).

### Prior Art Documents

### Patent Documents

Patent Document 1: JP 2013-147600 A

Patent Document 2: JP 2014-224189 A

Patent Document 3: JP 2019-009237 A

### SUMMARY OF THE INVENTION

The conventional thermally conductive composition and sheet have problems of low resilience and interfacial peeling of the resin from the surface of thermally conductive particles due to stress.

To solve these conventional problems, the present invention provides a thermally conductive composition that has high thermal conductive properties and excellent resilience and that can prevent interfacial peeling due to stress, a thermally conductive sheet including the thermally conductive composition, and a method for producing the thermally conductive sheet.

A thermally conductive composition of the present invention contains a base polymer, an adhesive polymer, and thermally conductive particles. A thermal conductivity of the thermally conductive composition is 0.3 W/m·K or more. The base polymer is a silicone polymer. The adhesive polymer contains a methyl hydrogen polysiloxane, an epoxy group-containing alkyltrialkoxysilane, and a cyclic polysiloxane oligomer. An amount of the adhesive polymer is 5 to 35 parts by weight with respect to 100 parts by weight of the base polymer.

A thermally conductive sheet of the present invention includes the thermally conductive composition in the form of a sheet.

A method for producing a thermally conductive sheet of the present invention uses the thermally conductive composition. The method includes mixing the base polymer, the adhesive polymer, and the thermally conductive particles to form a compound, molding the compound into a sheet, and then curing the sheet.

The present invention can provide a thermally conductive composition that has excellent resilience and prevents interfacial peeling due to stress, since the thermally conductive composition contains the predetermined amounts of a base polymer, an adhesive polymer, and thermally conductive particles. The present invention also can provide a thermally conductive sheet including the thermally conductive composition and a method for producing the thermally conductive sheet.

### BRIEF DESCRIPTION OF THE DRAWINGS

FIGS. 1A to 1B are diagrams illustrating a method for measuring a thermal conductivity used in an example of the present invention.

FIG. 2 is a diagram illustrating a method for measuring a tensile lap-shear strength used in an example of the present invention.

FIG. 3 is a diagram illustrating a method for performing a compression test used in an example of the present invention.

### DETAILED DESCRIPTION OF THE INVENTION

The present inventors mixed thermally conductive inorganic particles with a silicone polymer (base polymer), e.g., to increase the thermal conductivity. The resulting mixture was formed into a sheet, and then the sheet was subjected to a compression test. As a result, cracks appeared in the sheet. In order to investigate the cause of the cracks, the sheet was analyzed using CAE (computer aided engineering). The present inventors identified a strong stress generated at the interface of the inorganic particles as a starting point from which the cracks were developed. The present inventors found that the addition of a particular adhesive polymer was effective in reducing the cracks. The present invention has been completed based on this idea.

The present invention is directed to a thermally conductive composition that contains a base polymer, an adhesive polymer, and thermally conductive particles. The thermal conductivity of the thermally conductive composition is 0.3 W/m·K or more, preferably 0.5 W/m·K or more, and further preferably 1.0 W/m·K or more. The upper limit is preferably 15 W/m·K or less. The thermally conductive composition also has electrical insulation properties.

The base polymer is a silicone polymer. The silicone polymer has a high heat resistance, and there is no problem with heat resistance even if the silicone polymer undergoes a power cycle while it is being compressed. Thus, the silicone polymer is not likely to be degraded or decomposed. In this case, the “power cycle” means a test in which the power (electric power) of a device is repeatedly turned ON/OFF (cycle), and a change in the characteristic values of each component in the device before and after the cycle is confirmed.

The tensile lap-shear strength of the adhesive polymer with respect to an aluminum plate is preferably 50 N/cm² or more, more preferably 80 N/cm² or more, and further preferably 100 N/cm² or more.

The adhesive polymer preferably contains a methyl hydrogen polysiloxane, an epoxy group-containing alkyltrialkoxysilane, and a cyclic polysiloxane oligomer. Thus, the adhesive polymer can maintain high adhesiveness to the inorganic particles.

The base polymer is preferably an addition curable silicone polymer.

This is because curing of the addition curable silicone polymer can be easily controlled as compared to a peroxide curable silicone polymer and a condensation curable silicone polymer. In particular, the use of the condensation curable silicone polymer may result in insufficient curing of the inside of the silicone polymer and produce a by-product such as alcohol.

Therefore, the addition curable silicone polymer is preferred.

It is preferable that the thermally conductive composition further contains a silicone oil. The presence of the adhesive polymer is likely to increase the viscosity of the materials before curing or make the cured product harder. When a silicone oil is added, the viscosity of the materials before curing is reduced and the workability is improved. Moreover, the cured product becomes soft. The amount of the silicone oil added is preferably 5 to 30 parts by weight with respect to 100 parts by weight of the base polymer in terms of curability and workability.

The thermally conducive particles are preferably composed of at least one selected from alumina, zinc oxide, magnesium oxide, aluminum nitride, boron nitride, aluminum hydroxide, and silica. This is because these particles have high thermal conductive properties and excellent electrical insulation properties, and are also easy to use as heat dissipating materials.

The thermally conductive composition is preferably formed into a sheet.

The thermally conductive composition in the form of a sheet has good usability.

In addition to the sheet, the thermally conductive composition may be a potting material. The potting material is synonymous with a casting material. The thermally conductive composition is in an uncured state when used as a potting material. In this case, the thermally conducive composition is cured after it has been placed in a mold.

The amount of the thermally conductive particles is preferably 100 to 3000 parts by weight with respect to 100 parts by weight of a matrix component. This allows the thermally conductive composition to have a thermal conductivity of 0.3 W/m·K or more. The amount of the thermally conductive particles is more preferably 400 to 3000 parts by weight, and further preferably 800 to 3000 parts by weight with respect to 100 parts by weight of the matrix component. The matrix component is a mixture of the base polymer, the adhesive polymer, and the silicone oil.

The thermally conductive particles may be surface treated with a silane compound, a titanate compound, an aluminate compound, or partial hydrolysates thereof. This can prevent the deactivation of a curing catalyst or a crosslinking agent and improve the storage stability.

A method for producing a thermally conductive composition of the present invention includes mixing the matrix component, the thermally conductive inorganic particles, a catalyst, and other additives to form a compound, molding the compound into a sheet, and then curing the sheet. The addition ratio of the adhesive polymer is preferably 5 to 35 parts by weight with respect to 100 parts by weight of the base polymer.

The adhesive polymer preferably contains a methyl hydrogen polysiloxane, an epoxy group-containing alkyltrialkoxysilane, and a cyclic polysiloxane oligomer. Examples of the epoxy group-containing alkyltrialkoxysilane include γ-glycidoxypropyltrimethoxysilane expressed by the following chemical formula (chemical formula 1). Examples of the cyclic polysiloxane oligomer include octamethylcyclotetrasiloxane expressed by the following chemical formula (chemical formula 2).

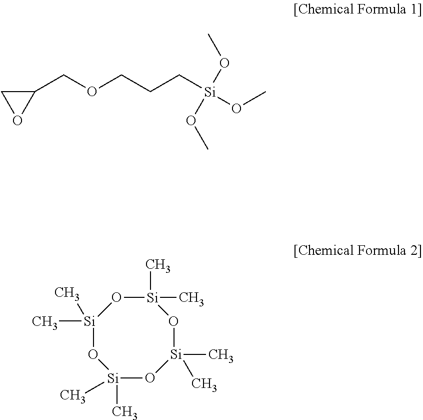

Next, the base polymer component (component A), a crosslinking component (component B), and a catalyst component (component C) that are contained in the base polymer will be described. (1) Base polymer component (component A)

The base polymer component is an organopolysiloxane having two or more alkenyl groups bonded to silicon atoms per molecule. The organopolysiloxane having two or more alkenyl groups is the base resin (base polymer component) of the thermally conductive composition of the present invention. In the organopolysiloxane, two or more alkenyl groups having 2 to 8 carbon atoms, and preferably 2 to 6 carbon atoms such as vinyl groups or allyl groups are bonded to the silicon atoms per molecule. The viscosity of the organopolysiloxane is preferably 10 to 100,000 mPa·s, and more preferably 100 to 10,000 mPa·s at 25° C. in terms of packing properties of the thermally conductive particles and curability.

Specifically, an organopolysiloxane expressed by the following general formula (chemical formula 3) is used. The organopolysiloxane has an average of two or more alkenyl groups per molecule, in which the alkenyl groups are bonded to silicon atoms at both ends of the molecular chain. The organopolysiloxane is a linear organopolysiloxane whose side chains are blocked with alkyl groups. Moreover, the linear organopolysiloxane may include a small amount of branched structure (trifunctional siloxane units) in the molecular chain.

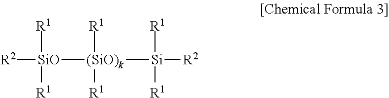

In the formula, R¹ represents substituted or unsubstituted monovalent hydrocarbon groups that are the same as or different from each other and have no aliphatic unsaturated bond, R² represents alkenyl groups, and k represents 0 or a positive integer. The monovalent hydrocarbon groups represented by R¹ have, e.g., 1 to 10 carbon atoms, and more preferably 1 to 6 carbon atoms. Specific examples of the monovalent hydrocarbon groups include the following:

alkyl groups such as methyl, ethyl, propyl, isopropyl, butyl, isobutyl, tert-butyl, pentyl, neopentyl, hexyl, cyclohexyl, octyl, nonyl, and decyl groups; aryl groups such as phenyl, tolyl, xylyl, and naphthyl groups; aralkyl groups such as benzyl, phenylethyl, and phenylpropyl groups; and substituted forms of these groups in which some or all hydrogen atoms are substituted by halogen atoms (fluorine, bromine, chlorine, etc.) or cyano groups, including halogen-substituted alkyl groups such as chloromethyl, chloropropyl, bromoethyl, and trifluoropropyl groups and cyanoethyl groups. The alkenyl groups represented by R² have, e.g., 2 to 6 carbon atoms, and more preferably 2 to 3 carbon atoms. Specific examples of the alkenyl groups include vinyl, allyl, propenyl, isopropenyl, butenyl, isobutenyl, hexenyl, and cyclohexenyl groups. In particular, the vinyl group is preferred. In the general formula (chemical formula 3), k is typically 0 or a positive integer satisfying 0≤k≤10000, preferably 5≤k≤2000, and more preferably 10≤k≤1200.

The component A may also include an organopolysiloxane having three or more, typically 3 to 30, and preferably about 3 to 20, alkenyl groups bonded to silicon atoms per molecule. The alkenyl groups have 2 to 8 carbon atoms, and preferably 2 to 6 carbon atoms and can be, e.g., vinyl groups or allyl groups.

The molecular structure may be a linear, ring, branched, or three-dimensional network structure. The organopolysiloxane is preferably a linear organopolysiloxane in which the main chain is composed of repeating diorganosiloxane units, and both ends of the molecular chain are blocked with triorganosiloxy groups.

Each of the alkenyl groups may be bonded to any part of the molecule. For example, the alkenyl group may be bonded to either a silicon atom that is at the end of the molecular chain or a silicon atom that is not at the end (but in the middle) of the molecular chain. In particular, a linear organopolysiloxane expressed by the following general formula (chemical formula 4) is preferred.

The linear organopolysiloxane has 1 to 3 alkenyl groups on each of the silicon atoms at both ends of the molecular chain. In this case, however, if the total number of the alkenyl groups bonded to the silicon atoms at both ends of the molecular chain is less than 3, at least one alkenyl group is bonded to the silicon atom that is not at the end (but in the middle) of the molecular chain (e.g., as a substituent in the diorganosiloxane unit). As described above, the viscosity of the linear organopolysiloxane is preferably 10 to 100,000 mPa·s at 25° C. in terms of workability and curability. Moreover, the linear organopolysiloxane may include a small amount of branched structure (trifunctional siloxane units) in the molecular chain.

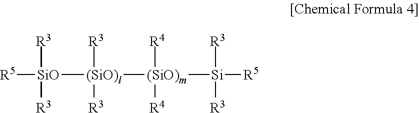

In the formula, R³ represents substituted or unsubstituted monovalent hydrocarbon groups that are the same as or different from each other, and at least one of them is an alkenyl group, R⁴ represents substituted or unsubstituted monovalent hydrocarbon groups that are the same as or different from each other and have no aliphatic unsaturated bond, R⁵ represents alkenyl groups, and 1 and m represent 0 or a positive integer. The monovalent hydrocarbon groups represented by R³ preferably have 1 to 10 carbon atoms, and more preferably 1 to 6 carbon atoms. Specific examples of the monovalent hydrocarbon groups include the following: alkyl groups such as methyl, ethyl, propyl, isopropyl, butyl, isobutyl, tert-butyl, pentyl, neopentyl, hexyl, cyclohexyl, octyl, nonyl, and decyl groups; aryl groups such as phenyl, tolyl, xylyl, and naphthyl groups; aralkyl groups such as benzyl, phenylethyl, and phenylpropyl groups; alkenyl groups such as vinyl, allyl, propenyl, isopropenyl, butenyl, hexenyl, cyclohexenyl, and octenyl groups; and substituted forms of these groups in which some or all hydrogen atoms are substituted by halogen atoms (fluorine, bromine, chlorine, etc.) or cyano groups, including halogen-substituted alkyl groups such as chloromethyl, chloropropyl, bromoethyl, and trifluoropropyl groups and cyanoethyl groups.

The monovalent hydrocarbon groups represented by R⁴ also preferably have 1 to 10 carbon atoms, and more preferably 1 to 6 carbon atoms. The monovalent hydrocarbon groups may be the same as the specific examples of R′, but do not include an alkenyl group. The alkenyl groups represented by R⁵ have, e.g., 2 to 6 carbon atoms, and more preferably 2 to 3 carbon atoms. Specific examples of the alkenyl groups are the same as those of R² in the general formula (chemical formula 3), and the vinyl group is preferred.

In the general formula (chemical formula 4), 1 and m are typically 0 or positive integers satisfying 0<1+m≤10000, preferably 5≤1+m≤2000, and more preferably 10≤1+m≤1200. Moreover, 1 and m are integers satisfying 0<1/(1+m)≤0.2, and preferably 0.0011≤1(1+m)≤0.1.

(2) Crosslinking Component (Component B)

The organohydrogenpolysiloxane of the component B acts as a crosslinking agent. The addition reaction (hydrosilylation) between Sill groups in the component B and alkenyl groups in the component A produces a cured product. Any organohydrogenpolysiloxane that has two or more hydrogen atoms (i.e., Sill groups) bonded to silicon atoms per molecule may be used. The molecular structure of the organohydrogenpolysiloxane may be a linear, ring, branched, or three-dimensional network structure. The number of silicon atoms in a molecule (i.e., the degree of polymerization) may be 2 to 1000, and preferably about 2 to 300.

The locations of the silicon atoms to which the hydrogen atoms are bonded are not particularly limited. The silicon atoms may be either at the ends or not at the ends (but in the middle) of the molecular chain. The organic groups bonded to the silicon atoms other than the hydrogen atoms may be, e.g., substituted or unsubstituted monovalent hydrocarbon groups that have no aliphatic unsaturated bond, which are the same as those of R¹ in the general formula (chemical formula 3).

The organohydrogenpolysiloxane of the component B may have the following structure.

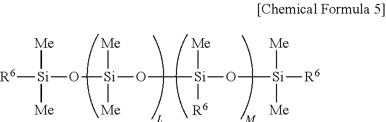

In the formula, R⁶ may be the same as or different from each other and represents hydrogen, alkyl groups, phenyl groups, epoxy groups, acryloyl groups, methacryloyl groups, or alkoxy groups, and at least two of them are hydrogen. L represents an integer of 0 to 1000, and preferably 0 to 300, and M represents an integer of 1 to 200.

(3) Catalyst Component (Component C)

The catalyst component of the component C accelerates the curing of the composition. The component C may be a catalyst used for a hydrosilylation reaction. Examples of the catalyst include platinum group metal catalysts such as platinum-based, palladium-based, and rhodium-based catalysts. The platinum-based catalysts include, e.g., platinum black, platinum chloride, chloroplatinic acid, a reaction product of chloroplatinic acid and monohydric alcohol, a complex of chloroplatinic acid and olefin or vinylsiloxane, and platinum bisacetoacetate. The component C may be mixed in an amount necessary for curing. The amount of the component C can be appropriately adjusted in accordance with the desired curing rate or the like. The component C is preferably added at a concentration of 0.01 to 1000 ppm based on the weight of metal atoms with respect to the component A.

(4) Thermally conductive particles The thermally conductive particles are preferably added in an amount of 100 to 3000 parts by weight with respect to 100 parts by weight of the matrix component. The addition of the thermally conductive particles can maintain a high thermal conductivity. The thermally conductive particles are preferably composed of at least one selected from alumina, zinc oxide, magnesium oxide, aluminum nitride, boron nitride, aluminum hydroxide, and silica. The thermally conductive particles may have various shapes such as spherical, scaly, and polyhedral. When alumina is used, α-alumina with a purity of 99.5% by weight or more is preferred.

The thermally conductive particles may include at least two types of inorganic particles with different average particle sizes. This is because small-size inorganic particles fill the spaces between large-size inorganic particles, which can provide nearly the closest packing and improve the thermal conductive properties.

It is preferable that the inorganic particles are surface treated with a silane compound or its partial hydrolysate. The silane compound is expressed by RₐSi(OR′)₃₋ₐ, where R represents a substituted or unsubstituted organic group having 1 to 20 carbon atoms, R′ represents an alkyl group having 1 to 4 carbon atoms, and a is 0 or 1. Examples of an alkoxysilane compound (simply referred to as “silane” in the following) expressed by RₐSi(OR′)₃₋ₐ, where R represents a substituted or unsubstituted organic group having 1 to 20 carbon atoms, R′ represents an alkyl group having 1 to 4 carbon atoms, and a is 0 or 1, include the following: methyltrimethoxysilane; ethyltrimethoxysilane; propyltrimethoxysilane; butyltrimethoxysilane; pentyltrimethoxysilane; hexyltrimethoxysilane; hexyltriethoxysilane; octyltrimethoxysilane; octyltriethoxysilane; decyltrimethoxysilane; decyltriethoxysilane; dodecyltrimethoxysilane; dodecyltriethoxysilane; hexadecyltrimethoxysilane; hexadecyltriethoxysilane; octadecyltrimethoxysilane; and octadecyltriethoxysilane. These silane compounds may be used individually or in combinations of two or more. The alkoxysilane and one-end silanol siloxane may be used together as the surface treatment agent. In this case, the surface treatment may include adsorption in addition to a covalent bond.

(5) Silicone Oil

The silicone oil is preferably a polydimethylsiloxane-based silicone oil. The molecular weight of the silicone oil is preferably 1000 to 20000. The viscosity of the silicone oil is preferably 10 to 10000 mPa·s (25° C.), which is measured by a rotational viscometer.

(6) Other Additives

The composition of the present invention may include components other than the above as needed. For example, the composition may include an inorganic pigment such as colcothar, and alkyltrialkoxysilane used, e.g., for the surface treatment of a filler. Moreover, alkoxy group-containing silicone may be added, e.g., for the surface treatment of a filler.

### EXAMPLES

Hereinafter, the present invention will be described by way of examples. However, the present invention is not limited to the following examples.

### <Thermal Conductivity>

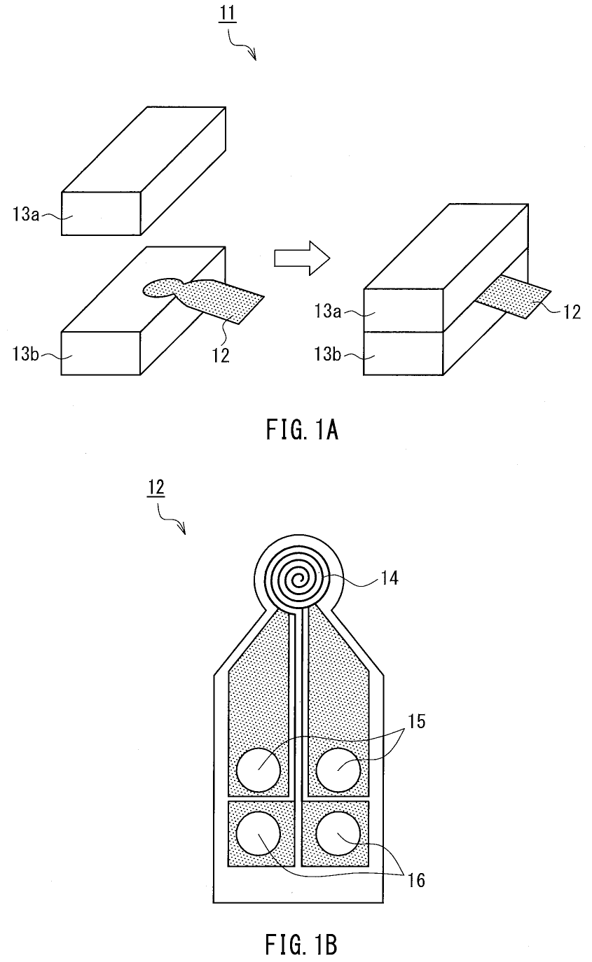

The thermal conductivity of the thermally conductive composition was measured by a hot disk (in accordance with ISO 22007-2). As shown in FIG. 1A, using a thermal conductivity measuring apparatus 11, a polyimide film sensor 12 was sandwiched between two thermally conductive composition samples 13a, 13b, and constant power was applied to the sensor 12 to generate a certain amount of heat. Then, the thermal characteristics were analyzed from a temperature rise value of the sensor 12. The sensor 12 has a tip 14 with a diameter of 7 mm. As shown in FIG. 1B, the tip 14 has electrodes with a double spiral structure. Moreover, an electrode 15 for an applied current and an electrode 6 for a resistance value (temperature measurement electrode) are located on the lower portion of the sensor 12. The thermal conductivity was calculated by the following formula 1.

$$λ = \frac{{P}_{0} \cdot D ( τ )}{{π}^{3 / 2} \cdot r} \cdot \frac{D ( τ )}{Δ T ( τ )} \qquad [ Formula 1 ]$$

γ: Therma conductivity (W/m·K)

P₀: Constant power (W)

r: Radius of sensor (m)

τ\sqrt{α·t/r²}

α: Thermal diffusivity of sample (m²/s)

t: Measuring time (s)

D (τ): Dimensionless function of τ

ΔT (τ): Temperature rise of sensor (K)

### <Viscosity>

The viscosity was measured in accordance with JIS K 7117-1:1999.

Measuring device: Brookfield rotational viscometer, type C (in which the spindle number is changed with the viscosity)

Rotational speed: 10 RPM

Measurement temperature: 25° C.

### <Hardness>

Asker C hardness was measured in accordance with JIS K 7312.

### <Tensile Lap-Shear Strength>

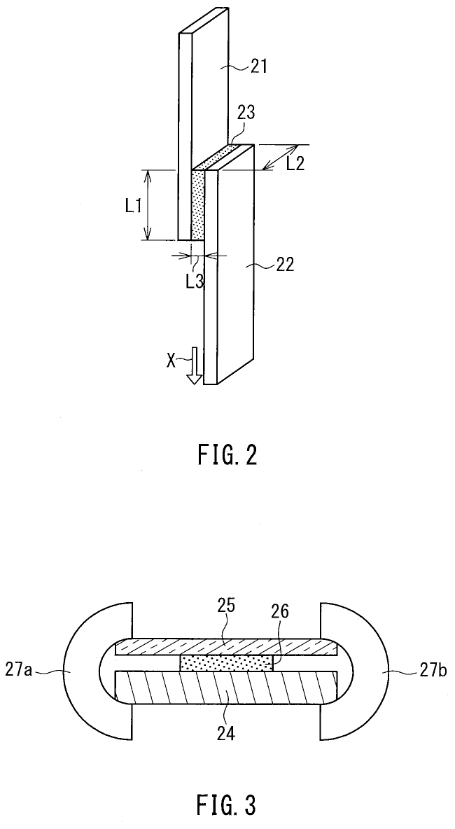

The tensile lap-shear strength was measured in accordance with JIS K 6850. FIG. 2 shows the measurement method.

Measuring device: UTM-4-100 manufactured by Toyo Baldwin Co., Ltd. Adhesive area: L1=3 cm, L2=2.5 cm

Test piece: A pair of aluminum alloy plates 21, 22 bonded together with a polymer 23 was used as a test piece. The aluminum alloy plates were fixed so that the thickness L3 of the polymer was 0.14 cm, and then the polymer was cured.

Test method: Using the test piece, a tensile test was performed. The maximum value (N) of the test force was taken as an adhesive break load (i.e., a load at break), and the value obtained by dividing the adhesive break load by the adhesive area (3 cm×2.5 cm) was a tensile lap-shear strength (N/cm²). Curing conditions: room temperature for 24 hours

Tensile Rate: 500 mm/min

### <Compression Test>

FIG. 3 shows the measurement method.

Measuring device: Autograph AGS-X manufactured by SHIMADZU CORPORATION

Thermally conductive composition 26: diameter of 15 mm, thickness of 2 mm

Compression rate: 5 mm/min

Compressive load value: 8000 N

Test method: The thermally conductive composition 26 was placed on the center of an aluminum plate 24 with a length of 100 mm, a width of 100 mm, and a thickness of 5 mm. Moreover, a tempered glass plate 25 with a length of 100 mm, a width of 100 mm, and a thickness of 2.7 mm was placed on the thermally conductive composition 26. Then, the thermally conductive composition 26 was compressed until the compressive load value reached 8000 N, and the aluminum plate 24 and the tempered glass plate 25 were fixed at four points using double clips 27a, 27b. The thermally conductive composition 26 was allowed to stand for 1 hour, and subsequently checked for the presence of a crack.

### Examples 1 to 3

(1) Adhesive Polymer

A commercially available adhesive polymer was used. The adhesive polymer contained 20 to 30% by weight of methyl hydrogen polysiloxane, 1 to 10% by weight of γ-glycidoxypropyltrimethoxysilane expressed by the chemical formula 1, 0.1 to 1% by weight of octamethylcyclotetrasiloxane expressed by the chemical formula 2, 1 to 10% by weight of carbon black, and the rest silicone polymer.

Table 1 shows the tensile lap-shear strength of the adhesive polymer with respect to the aluminum plate.

(2) Base polymer

The base polymer was a commercially available two-part room temperature curing silicone polymer. The two-part room temperature curing silicone polymer was composed of a solution A and a solution B. The solution A previously contained a base polymer component and a platinum-based catalyst. The solution B previously contained a base polymer component and a crosslinking component.

Table 1 shows the tensile lap-shear strength of the base polymer with respect to the aluminum plate.

TABLE 1

| | Tensile lap-shear strength (N/cm²) |
|---|---|
| Adhesive polymer | 112 |
| Base polymer | 27 |

(3) Silicone Oil

A dimethylpolysiloxane-based silicone oil with a viscosity of 97 mPa·s, which was measured by a rotational viscometer, was used.

(4) Thermally Conductive Particles

The thermally conductive particles were alumina particles with an average particle size of 28 μm.

(5) Production of Compound

The base polymer, the adhesive polymer, alumina, and a platinum-based catalyst were mixed well to form a compound. Table 2 shows the mixing ratio of the base polymer and the adhesive polymer.

(6) Formation of Thermally Conductive Composition

The compound was sandwiched between polyester (PET) films, rolled into a sheet with a thickness of 2 mm, and then cured at 100° C. for 2 hours.

### Comparative Examples 1 to 3

The experiments were performed in the same manner as Example 1 except that the mixing ratio of the base polymer and the adhesive polymer was shown in Table 2.

Table 2 show the conditions and physical properties of the thermally conductive compositions thus obtained.

TABLE 2

| | | Ex. 1 | Ex. 2 | Ex. 3 | Comp. Ex. 1 | Comp. Ex. 2 | Comp. Ex 3 |
|---|---|---|---|---|---|---|---|
| Base polymer (g) (X) | | 80 | 70 | 65 | 55 | 85 | 0 |
| Adhesive polymer (g) (Y) | | 5 | 15 | 20 | 30 | 0 | 85 |
| (Y/X) × 100 (parts by weight of | | 6 | 21 | 31 | 55 | 0 | 100 |
| adhesive polymer with respect to | | | | | | | |
| 100 parts by weight of base polymer) | | | | | | | |
| Silicone oil (g) | | 15 | 15 | 15 | 15 | 15 | 15 |
| Platinum-based catalyst (g) | | 4 | 4 | 4 | 4 | 4 | 4 |
| Alumina (g) | | 1560 | 1560 | 1560 | 1560 | 1560 | 1560 |
| Asker C hardness | Peak value (P) | 25 | 25 | 27 | 31 | 27 | 46 |
| | Steady-state value | 21 | 21 | 23 | 23 | 22 | 23 |
| | after 10 sec (T) | | | | | | |
| | Difference (P-T) | 4 | 4 | 4 | 8 | 5 | 23 |

| | | | | | | |
|---|---|---|---|---|---|---|
| Compression test to confirm the | absence | absence | absence | absence | presence | absence |
| presence or absence of cracks | | | | | | |
| Thermal conductivity (W/m · K) | 4.4 | 4.4 | 4.4 | 4.4 | 4.4 | 4.4 |

As can be seen from Table 2, the thermally conductive compositions containing the adhesive polymer did not have a crack in the compression test, and thus was able to reduce interfacial peeling due to stress.

In the thermally conductive compositions of Examples 1 to 3, there was a small difference between the peak value and the steady-state value of the Asker C hardness. Therefore, it was confirmed that the thermally conductive compositions of Examples 1 to 3 had excellent resilience.

### INDUSTRIAL APPLICABILITY

The thermally conductive composition of the present invention is useful as a heat dissipating material that is interposed between the heat generating member and the heat dissipating member of, e.g., electronic components such as LEDs and household electrical appliances, information and communication modules including optical communication equipment, and components mounted on vehicles. The thermally conductive composition of the present invention is also useful as a heat dissipating material for electronic components including semiconductors.

### DESCRIPTION OF REFERENCE NUMERALS

11 Thermal conductivity measuring apparatus

12 Sensor

13a, 13b Thermally conductive composition sample

14 Tip of the sensor

15 Electrode for applied current

16 Electrode for resistance value (temperature measurement electrode)

21, 22 Aluminum alloy plate

23 Polymer

24 Aluminum plate

25 Tempered glass plate

26 Thermally conductive composition

27a, 27b Double clip

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A thermally conductive composition comprising:
a base polymer;
an adhesive polymer; and
thermally conductive particles, wherein a thermal conductivity of the thermally conductive composition is 0.3 W/m·K or more,
the base polymer is a silicone polymer,
the adhesive polymer contains a methyl hydrogen polysiloxane, an epoxy group-containing alkyltrialkoxysilane, and a cyclic polysiloxane oligomer, and
an amount of the adhesive polymer is 5 to 35 parts by weight with respect to 100 parts by weight of the base polymer.

2. The thermally conducive composition according to claim 1, wherein a tensile lap-shear strength of the adhesive polymer with respect to an aluminum plate is 50 N/cm² or more.

3. The thermally conductive composition according to claim 1, wherein the base polymer is an addition curable silicone polymer.

4. The thermally conductive composition according to claim 1, further comprising a silicone oil.

5. The thermally conductive composition according to claim 1, wherein the thermally conductive particles are composed of at least one selected from a metal oxide, a metal hydroxide, a metal nitride, and silica.

6. The thermally conductive composition according to claim 1, wherein the thermally conductive particles are surface treated with a silane compound, a titanate compound, an aluminate compound, or partial hydrolysates thereof.

7. The thermally conductive composition according to claim 1, wherein the thermally conductive composition is formed into a sheet.

8. A thermally conductive sheet comprising a thermally conductive composition in the form of a sheet,
the thermally conductive composition comprising a base polymer, an adhesive polymer, and thermally conductive particles,
wherein a thermal conductivity of the thermally conductive composition is 0.3 W/m·K or more,
the base polymer is a silicone polymer,
the adhesive polymer contains a methyl hydrogen polysiloxane, an epoxy group-containing alkyltrialkoxysilane, and a cyclic polysiloxane oligomer, and
an amount of the adhesive polymer is 5 to 35 parts by weight with respect to 100 parts by weight of the base polymer.

9. The thermally conductive sheet according to claim 8, wherein a tensile lap-shear strength of the adhesive polymer with respect to an aluminum plate is 50 N/cm² or more.

10. The thermally conductive sheet according to claim 8, wherein the base polymer is an addition curable silicone polymer.

11. The thermally conductive sheet according to claim 8, wherein the thermally conductive composition further comprises a silicone oil.

12. The thermally conductive sheet according to claim 8, wherein the thermally conductive particles are composed of at least one selected from a metal oxide, a metal hydroxide, a metal nitride, and silica.

13. The thermally conductive sheet according to claim 8, wherein the thermally conductive particles are surface treated with a silane compound, a titanate compound, an aluminate compound, or partial hydrolysates thereof.

14. A method for producing a thermally conductive sheet using a thermally conductive composition,
the thermally conductive composition comprising a base polymer, an adhesive polymer, and thermally conductive particles,
wherein a thermal conductivity of the thermally conductive composition is 0.3 W/m·K or more,
the base polymer is a silicone polymer,
the adhesive polymer contains a methyl hydrogen polysiloxane, an epoxy group-containing alkyltrialkoxysilane, and a cyclic polysiloxane oligomer, and
an amount of the adhesive polymer is 5 to 35 parts by weight with respect to 100 parts by weight of the base polymer, the method comprising:
mixing the base polymer, the adhesive polymer, and the thermally conductive particles to form a compound;
molding the compound into a sheet, and then curing the sheet.

15. The method according to claim 14, wherein a tensile lap-shear strength of the adhesive polymer with respect to an aluminum plate is 50 N/cm² or more.

16. The method according to claim 14, wherein the base polymer is an addition curable silicone polymer.

17. The method according to claim 14, wherein the thermally conductive composition further comprises a silicone oil.

18. The method according to claim 14, wherein the thermally conductive particles are composed of at least one selected from a metal oxide, a metal hydroxide, a metal nitride, and silica.

19. The method according to claim 14, wherein the thermally conductive particles are surface treated with a silane compound, a titanate compound, an aluminate compound, or partial hydrolysates thereof.
